(19) United States
(12) Patent Application Publication
(10) Pub. No.: US 2013/0275265 A1
(43) Pub. Date: Oct. 17, 2013

(54) BUSINESS TO BUSINESS INTEGRATION SERVICES MARKETPLACE

(71) Applicants: Erik J. Burckart, Raleigh, NC (US); Paul A. Coniglio, Westport, CT (US); Michael R. Ingardia, Powell, OH (US); Andrew J. Ivory, Wake Forest, NC (US); Aaron K. Shook, Raleigh, NC (US)

(72) Inventors: Erik J. Burckart, Raleigh, NC (US); Paul A. Coniglio, Westport, CT (US); Michael R. Ingardia, Powell, OH (US); Andrew J. Ivory, Wake Forest, NC (US); Aaron K. Shook, Raleigh, NC (US)

(73) Assignee: INTERNATIONAL BUSINESS MACHINES CORPORATION, Armonk, NY (US)

(21) Appl. No.: 13/448,868

(22) Filed: Apr. 17, 2012

(51) Int. Cl. G06Q 30/06

(52) U.S. Cl. 705/26.41

(57) ABSTRACT

The present disclosure relates generally to a business to business (“B2B”) integration services marketplace. In various examples, a B2B integration services marketplace may be implemented in the form of systems, methods and/or algorithms.

### BACKGROUND

The present disclosure relates generally to a business to business (“B2B”) integration services marketplace.

In various examples, a B2B integration services marketplace may be implemented in the form of systems, methods and/or algorithms.

### DESCRIPTION OF RELATED ART

Several companies have internal services that they have built which have proven to be useful and valuable for internal and potentially external partner usage. For example, an airline may provide a service for booking tickets, selecting seats, and handling changes to reservations.

At first, these services may have been developed for internal usage. Eventually such services may be promoted as services that a given company may want to make available to partners (e.g., to avoid other companies from screen scraping their website).

Several websites publish their services application programming interface (“API”). Functions like WebSphere Services Registry and Repository help companies manage their services definitions and versioning—even service level agreements (“SLAs”). Another example beside WebSphere Services Registry and Repository is Glowpoint.

Further, various technologies provide applications for use (e.g., SAP Service Marketplace, IBM Smart Market). In addition, various services offer procurement solutions (e.g., Ariba).

### SUMMARY

In various embodiments, systems, methods and/or algorithms for providing software services to and/or among business partners are provided.

In one example, the systems, methods and/or algorithms may comprise: providing a services broker in a software-as-a-service (“SaaS”) environment; providing a set of software services for usage by one or more of a plurality of business partners (e.g., as defined in a social network), each of the set of software services having a pricing and/or a service level agreement (“SLA”) associated therewith; wherein, provisioning (e.g., automated provisioning) of the one or more software services of the set of software services is initiated by pushing information from a custom questionnaire (e.g., completed by one or more requesting business partners), the custom questionnaire information being pushed between the business partners (e.g., from one or more requesting business partners to one or more software services providing business partners) via the services broker.

In another example, a mechanism may be provided that enables a company to monetize an investment (e.g., an investment in one or more internal software services that the company has built which have proven to be useful and valuable for internal usage as well as potentially valuable for external partner usage).

In another example, a mechanism may enable a company to provide one or more SLAs for certain business partner(s).

In another example, a mechanism may be provided that integrates B2B relationships, contracts, and billing.

In one embodiment, a method implemented in a computer system for providing software service is provided, the method comprising: maintaining, by a software service broker, data identifying a plurality of software service selling business partners; maintaining, by the software service broker, data identifying a plurality of software service buying business partners; receiving by the software service broker, from each of the software service selling business partners, respective data defining a set of software services, wherein the respective data defining the set of software services includes for each of the software service selling business partners terms directed to at least one of an associated pricing and an associated service level agreement; providing by the software service broker a search functionality that identifies at least one of the software services in the sets of defined software services; receiving by the software service broker, from a first one of the software service buying business partners, a search request to identify at least one of the software services in the sets of defined software services; providing, by the software service broker, to the first one of the software service buying business partners, a search result identifying at least one of the software services in the sets of defined software services; receiving by the software service broker, from the first software service buying business partner, data associated with a questionnaire, wherein the data associated with the questionnaire specifies at least one of the software services in the search result to which the first software service buying business partner requests a subscription, and wherein the questionnaire includes an agreement by the first software service buying business partner to the terms for the requested subscription including at least one of the associated pricing and the associated service level agreement; receiving by the software service broker, from the first software service buying business partner, software service query data for querying the at least one software service to which the first software service buying business partner subscribes, wherein the software service query data is in a first format; converting, by the software service broker, the software service query data in the first format into software service query data in a second format, wherein the second format is different from the first format; sending by the software service broker, to the software service selling business partner associated with the subscription, the software service query data in the second format; receiving by the software service broker, from the software service selling business partner associated with the subscription, software service response data, wherein the software service response data is responsive to the software service query data; sending by the software service broker, to the first software service buying business partner, the software service response data; and tracking, by the software service broker, usage by the first software service buying business partner of the at least one software service to which the first software service buying business partner subscribes.

In another embodiment, a computer readable storage medium, tangibly embodying a program of instructions executable by the computer for providing software service is provided, the program of instructions, when executing, performing the following steps: maintaining, by a software service broker, data identifying a plurality of software service selling business partners; maintaining, by the software service broker, data identifying a plurality of software service buying business partners; receiving by the software service broker, from each of the software service selling business partners, respective data defining a set of software services, wherein the respective data defining the set of software services includes for each of the software service selling business partners terms directed to at least one of an associated pricing and an associated service level agreement; providing by the software service broker a search functionality that identifies at least one of the software services in the sets of defined software services; receiving by the software service broker, from a first one of the software service buying business partners, a search request to identify at least one of the software services in the sets of defined software services; providing, by the software service broker, to the first one of the software service buying business partners, a search result identifying at least one of the software services in the sets of defined software services; receiving by the software service broker, from the first software service buying business partner, data associated with a questionnaire, wherein the data associated with the questionnaire specifies at least one of the software services in the search result to which the first software service buying business partner requests a subscription, and wherein the questionnaire includes an agreement by the first software service buying business partner to the terms for the requested subscription including at least one of the associated pricing and the associated service level agreement; receiving by the software service broker, from the first software service buying business partner, software service query data for querying the at least one software service to which the first software service buying business partner subscribes, wherein the software service query data is in a first format; converting, by the software service broker, the software service query data in the first format into software service query data in a second format, wherein the second format is different from the first format; sending by the software service broker, to the software service selling business partner associated with the subscription, the software service query data in the second format; receiving by the software service broker, from the software service selling business partner associated with the subscription, software service response data, wherein the software service response data is responsive to the software service query data; sending by the software service broker, to the first software service buying business partner, the software service response data; and tracking, by the software service broker, usage by the first software service buying business partner of the at least one software service to which the first software service buying business partner subscribes.

In another embodiment, a computer-implemented system for providing software service is provided, the system comprising: an input element, wherein the input element: (a) receives data identifying a plurality of software service selling business partners; (b) receives data identifying a plurality of software service buying business partners; and (c) receives, from each of the software service selling business partners, respective data defining a set of software services, wherein the respective data defining the set of software services includes for each of the software service selling business partners terms directed to at least one of an associated pricing and an associated service level agreement; a search element, wherein the search element: (a) receives, from a first one of the software service buying business partners, a search request to identify at least one of the software services in the sets of defined software services; (b) provides a search functionality such that at least one of the software services in the sets of defined software services can be identified; and (c) provides, to the first one of the software service buying business partners, a search result identifying at least one of the software services in the sets of defined software services; a configuration element, wherein the configuration element: (a) receives, from the first software service buying business partner, data associated with a questionnaire, wherein the data associated with the questionnaire specifies at least one of the software services in the search result to which the first software service buying business partner requests a subscription, and wherein the questionnaire includes an agreement by the first software service buying business partner to the terms for the requested subscription including at least one of the associated pricing and the associated service level agreement; a software service utilization element, wherein the software service utilization element: (a) receives, from the first software service buying business partner, software service query data for querying the at least one software service to which the first software service buying business partner subscribes, wherein the software service query data is in a first format; (b) converts the software service query data in the first format into software service query data in a second format, wherein the second format is different from the first format; (c) sends, to the software service selling business partner associated with the subscription, the software service query data in the second format; (d) receives, from the software service selling business partner associated with the subscription, software service response data, wherein the software service response data is responsive to the software service query data; and (e) sends, to the first software service buying business partner, the software service response data; and a tracking element, wherein the tracking element: (a) tracks usage by the first software service buying business partner of the at least one software service to which the first software service buying business partner subscribes.

### BRIEF DESCRIPTION OF THE DRAWINGS

Various objects, features and advantages of the present invention will become apparent to one skilled in the art, in view of the following detailed description taken in combination with the attached drawings, in which:

FIG. 1 depicts a diagram of data flow according to one embodiment of the present invention;

FIGS. 2A, 2B, 2C and 2D depict a flowchart according to one embodiment of the present invention;

FIG. 3 depicts a block diagram of a system according to one embodiment of the present invention;

FIG. 4 depicts an example set of business partners and two example business partner subsets according to one embodiment of the present invention;

FIG. 5 depicts a block diagram of a system according to one embodiment of the present invention; and

FIG. 6 depicts a block diagram of a system according to one embodiment of the present invention.

### DETAILED DESCRIPTION

In various examples, a B2B integration services marketplace may be implemented in the form of systems, methods and/or algorithms.

For the purposes of describing and claiming the present invention the term “software service” is intended to refer to any desired types of services. Such service may include, but not be limited to: airline flight booking, hotel booking, car rental booking, cruise booking, package tracking, shipping and/or warehousing.

For the purposes of describing and claiming the present invention the term “data associated with a questionnaire” is intended to refer to data used to help configure (and/or provision) one or more software services, data used to form an agreement or contract between a buyer and a seller with regard to prices for one or more software services, and/or data used to form an agreement or contract between a buyer and a seller with regard to a service level agreement for one or more software services.

For the purposes of describing and claiming the present invention the term “software service query data” is intended to refer to data requesting an instance of a software service (e.g., an airline flight booking search query).

For the purposes of describing and claiming the present invention the term “software service response data” is intended to refer to data responding to a requested instance of a software service (e.g., an airline flight booking search query answer).

For the purposes of describing and claiming the present invention the term “Internet access” is intended to refer to the ability to connect (e.g., bi-directionally) with the Internet. In various examples, Internet access as applied to embodiments of the present invention may be selected from the group including (but not limited to): access via Wi-Fi, access via Bluetooth, access via a cell phone network (e.g., a 2G network, a 3G network, or a 4G network), and access via a wired mechanism.

For the purposes of describing and claiming the present invention the term “prior relationship” is intended to refer to two (or more) parties having had prior business dealings with each other, two (or more) parties having had prior social dealings with each other, two (or more) parties having been part of a social network and/or the like.

In one embodiment, various systems, methods and/or algorithms provide for the registry, search, and integration of software services(s) available to one or more partners (e.g., business partner(s)) in a community. These software services may be configured/provisioned (e.g., automatically configured/provisioned) within an Enterprise Service Bus (“ESB”), in an application development environment, at runtime and/or within a business process (such as, for example, BlueWorks Live). In one example, the provider(s) of the software service(s) may provide all or some of the billing associated with the software service(s). In another example, intermediary broker(s) of the software service(s) may provide all or some of the billing associated with the software service(s). Further, integration as a service may provide point to point integration and/or transformation as needed (e.g., for upsold charges).

In one example, a services marketplace may be implemented in the form of systems, methods and/or algorithms with the ability to publish from a services registry a set of services with a pricing and/or SLA model available for partner usage.

In one specific example, such a services marketplace may use a multi-tenant registry and repository in the cloud.

In another specific example, a partner (e.g., a B2B partner) may be provided a mechanism that allows the partner to self provision and manage themselves by filling out a custom questionnaire and pushing that information (e.g., to on premises system(s)) to manage the user access and/or the service level agreement(s).

In another specific example, a service broker may be provided in an SaaS environment. This environment may allow for automated provisioning and may provide billing, metering, throttling and/or controlling as well as security and SLA management on behalf of the company exposing the service(s).

In another specific example, an integration service may connect two partners to a software services broker that knows how to connect to the company exposing the services.

In another specific example, an integration service may connect two partners to a software services broker that is hosted by one of the partners (e.g., the partner proving the software service(s)).

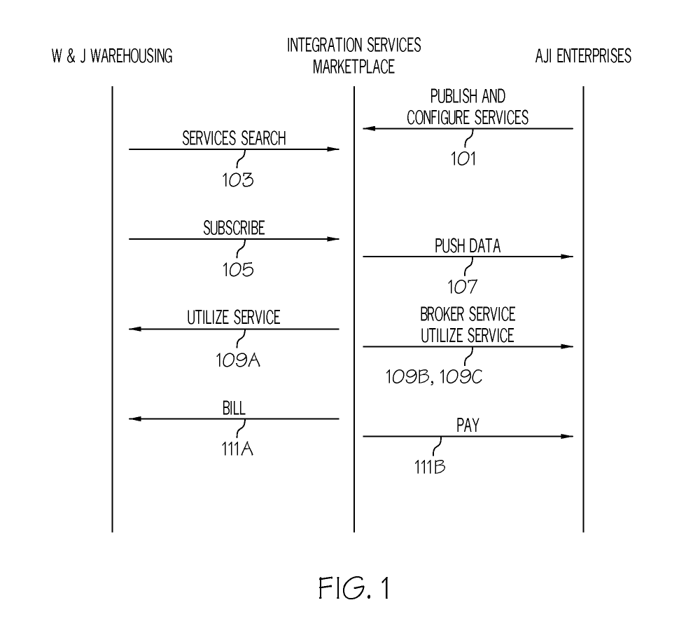

Referring now to FIG. 1, a diagram showing one example of the present invention is shown. As seen in this figure, a first company (given here the fictional name “AJI Enterprises”) has a software service for scheduling the delivery of products and services anywhere. This software service is considered to be the best in class delivery software service and they have invested a lot of resources in providing the data services to provide their customers the visibility into the delivery no matter where the delivery is in the process. AJI Enterprises has decided that they would like to make their software services available to their largest partners with some cost recovery billing. A second company (given here the fictional name “W&J Warehousing”) is looking to connect their systems with some visibility into the delivery of products in and out of their warehouse. W&J Warehousing searches in the Integration Services Marketplace according to an embodiment of the present invention and sees that their partner, AJI Enterprises, provides software services to give them the visibility into the product delivery at a very low cost. A chance to utilize this service will enable W&J Warehousing to be more productive and save them the effort of creating their own software service.

Still referring to the example of FIG. 1, it is seen that at Step 101 AJI Enterprises publishes and configures their software services. AJI Enterprises trusts the Integration Services Marketplace for the security, brokering, and billing of their partner(s) for the cost recovery. AJI Enterprises is able to test the connection of the Integration Services Marketplace to their environment and when they verify the connection works, they make the software services live.

At Step 103 W&J Warehousing searches the Integration Services Marketplace for product delivery visibility and sees the AJI Enterprises software services.

At Step 105, W&J Warehousing fills out a custom questionnaire and is able to subscribe to the software services of AJI Enterprises in order to access the software services of AJI Enterprises. In one specific example, the Integration Services Marketplace gives W&J Warehousing the option to automatically provision their ESB with the necessary information to connect to the brokered software services.

At Step 107, information about the new subscriber (in this example, W&J Warehousing) is pushed by the Integration Services Marketplace to AJI Enterprises.

At Steps 109A, 109B and 109C, W&J Warehousing is able to connect and utilize the AJI Enterprises product delivery visibility software service. In one specific example, each time that W&J Warehousing calls or invokes the software services, the software services are brokered by the Integration Services Marketplace and a transformation occurs to get the data between W&J Warehousing and AJI Enterprises the way that they each want to use it.

At Steps 111A and 111B, the Integration Services Marketplace meters or computes W&J Warehousing's usage of the software services, bills W&J Warehousing (e.g., monthly), and provides a payment (e.g., monthly) to AJI Enterprises for W&J Warehousing's usage of the software services (in one example, each payment may be made to AJI Enterprises after W&J Warehousing pays each of its bills).

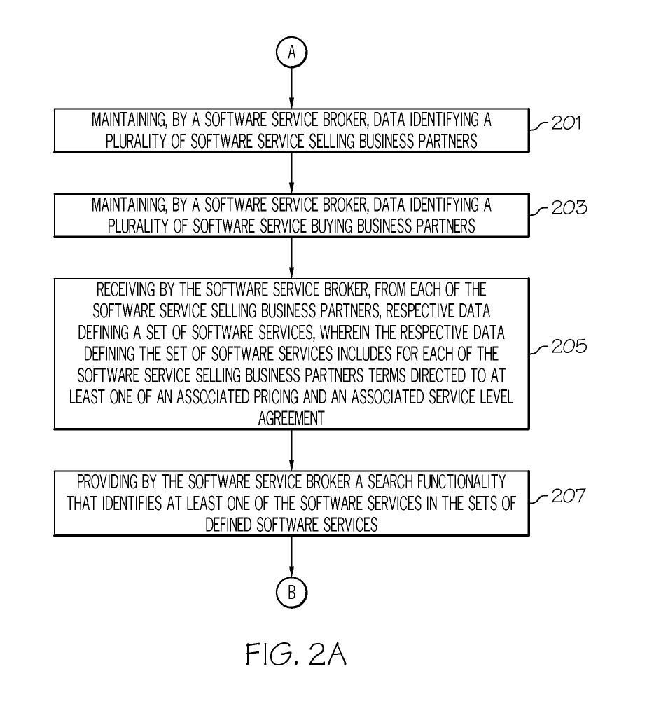

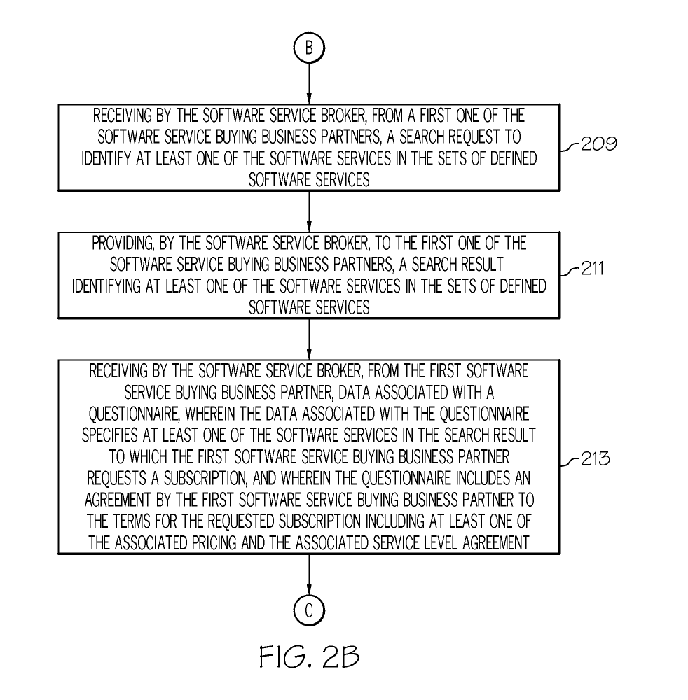

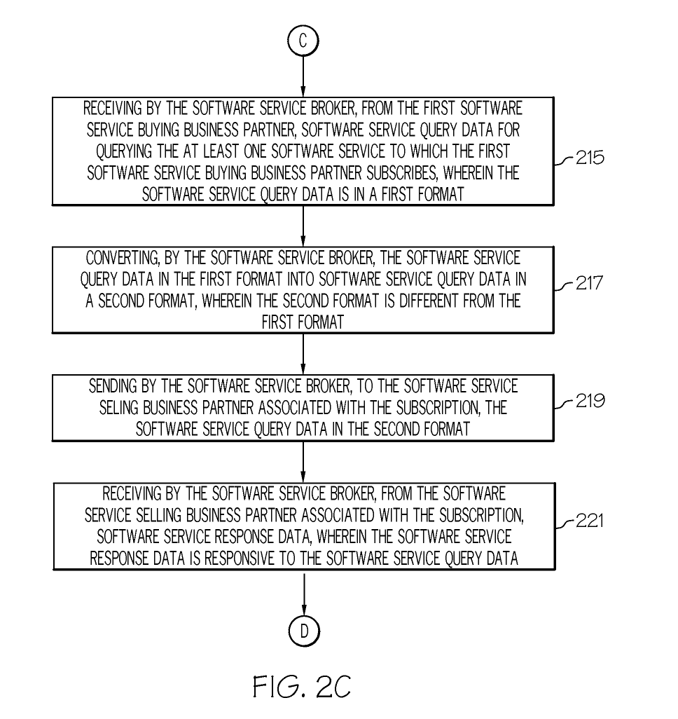

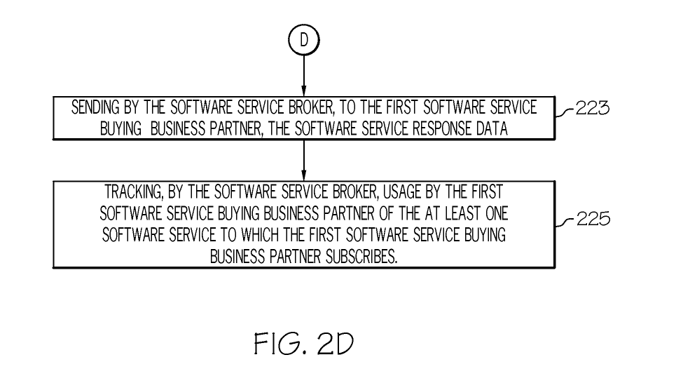

Referring now to FIGS. 2A, 2B, 2C and 2D, a flowchart according to one embodiment of the present invention is shown. As seen in these FIGS. 2A, 2B, 2C and 2D, the systems, methods and/or algorithms may comprise: Step 201—maintaining, by a software service broker, data identifying a plurality of software service selling business partners; Step 203—maintaining, by the software service broker, data identifying a plurality of software service buying business partners; Step 205—receiving by the software service broker, from each of the software service selling business partners, respective data defining a set of software services (e.g., at least one software service), wherein the respective data defining the set of software services includes for each of the software service selling business partners terms directed to at least one of an associated pricing and an associated service level agreement (in one specific example, this can be both an associated pricing and an associated service level agreement; in another specific example, different services from each seller may have the same pricing and/or service level agreement or different services from each seller may have different pricing and/or service level agreement); Step 207—providing by the software service broker a search functionality wherein at least one of the software services in the sets of defined software services can be identified; Step 209—receiving by the software service broker, from a first one of the software service buying business partners, a search request to identify at least one of the software services in the sets of defined software services; Step 211—providing, by the software service broker, to the first one of the software service buying business partners, a search result identifying at least one of the software services in the sets of defined software services; Step 213—receiving by the software service broker, from the first software service buying business partner, data associated with a questionnaire, wherein the data associated with the questionnaire specifies at least one of the software services in the search result to which the first software service buying business partner requests a subscription, and wherein the questionnaire includes an agreement by the first software service buying business partner to the terms for the requested subscription including at least one of the associated pricing and the associated service level agreement; Step 215—receiving by the software service broker, from the first software service buying business partner, software service query data for querying the at least one software service to which the first software service buying business partner subscribes, wherein the software service query data is in a first format; Step 217—converting, by the software service broker, the software service query data in the first format into software service query data in a second format, wherein the second format is different from the first format; Step 219—sending by the software service broker, to the software service selling business partner associated with the subscription, the software service query data in the second format; Step 221—receiving by the software service broker, from the software service selling business partner associated with the subscription, software service response data, wherein the software service response data is responsive to the software service query data; Step 223—sending by the software service broker, to the first software service buying business partner, the software service response data; and Step 225—tracking, by the software service broker, usage by the first software service buying business partner of the at least one software service to which the first software service buying business partner subscribes.

In another example, the systems, methods and/or algorithms may further comprise converting, by the software service broker, the software service response data from a third format into software service response data in a fourth format, wherein the third format is different from the fourth format; wherein the sending by the software service broker, to the first software service buying business partner, the software service response data comprises sending the software service response data in the fourth format.

In one example, each of the first format, the second format, the third format and the fourth format are all different.

In another example, the first format and the fourth format are the same and the second format and the third format are the same.

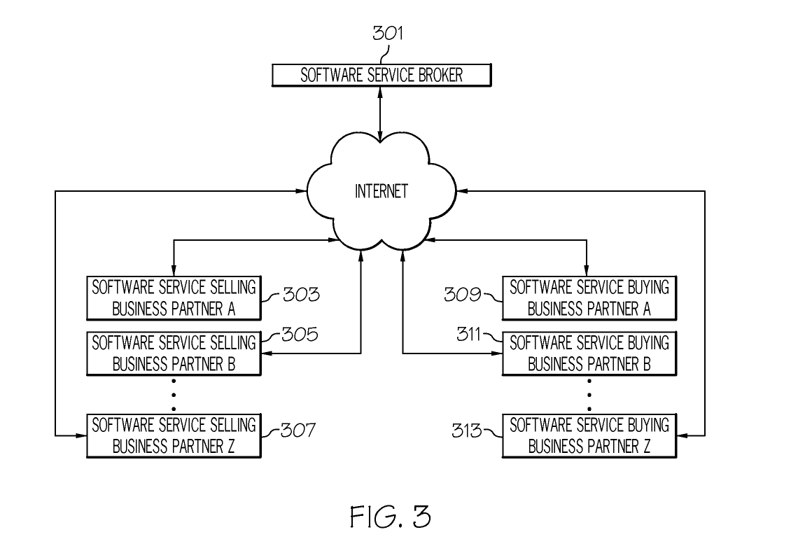

Referring now to FIG. 3, this figure depicts a block diagram of a system according to one embodiment of the present invention. As seen in this figure, Software Service Broker 301 may communicate via Internet access (e.g., bi-directionally) with any (or all) of: Software Service Selling Business Partner A (shown with call-out number 303), Software Service Selling Business Partner B (shown with call-out number 305), through Software Service Selling Business Partner Z (shown with call-out number 307). Of course, Software Service Broker 301 may communicate with any appropriate number of Software Service Selling Business Partner(s).

Further, Software Service Broker 301 may communicate via Internet access (e.g., bi-directionally) with any (or all) of: Software Service Buying Business Partner A (shown with call-out number 309), Software Service Buying Business Partner B (shown with call-out number 311), through Software Service Buying Business Partner Z (shown with call-out number 313). Of course, Software Service Broker 301 may communicate with any appropriate number of Software Service Buying Business Partner(s).

Of note, while FIG. 3 shows the various entities communicating, it is to be understood that this FIG. 3 is actually referring to communication by computer system(s) or the like that are owned, leased, operated, used by, in the possession of, and/or controlled by each of the entities.

In another embodiment, search results may be selected or generated based on data of business partners having prior relationships. In that aspect, the systems, methods and/or algorithms may comprise: maintaining, by a software service broker, data identifying a plurality of software service selling business partners; maintaining, by the software service broker, data identifying a plurality of software service buying business partners; maintaining, by the software service broker, data identifying a first subset of the group of software service selling business partners and software service buying business partners, wherein the first subset comprises at least one of the software service selling business partners having a prior relationship with at least one of the software service buying business partners; receiving by the software service broker, from each of the software service selling business partners, respective data defining a set of software services, wherein the respective data defining the set of software services includes for each of the software service selling business partners terms directed to at least one of an associated pricing and an associated service level agreement; providing by the software service broker a search functionality wherein at least one of the software services in the sets of defined software services can be identified; receiving by the software service broker, from a first one of the software service buying business partners in the first subset, a search request to identify at least one of the software services in the sets of defined software services; providing, by the software service broker, to the first one of the software service buying business partners, a search result identifying at least one of the software services in the sets of defined software services, wherein the search result is limited to the software service selling business partners in the first subset; receiving by the software service broker, from the first software service buying business partner, data associated with a questionnaire, wherein the data associated with the questionnaire specifies at least one of the software services in the search result to which the first software service buying business partner requests a subscription, and wherein the questionnaire includes an agreement by the first software service buying business partner to the terms for the requested subscription including at least one of the associated pricing and the associated service level agreement; receiving by the software service broker, from the first software service buying business partner, software service query data for querying the at least one software service to which the first software service buying business partner subscribes, wherein the software service query data is in a first format; converting, by the software service broker, the software service query data in the first format into software service query data in a second format, wherein the second format is different from the first format; sending by the software service broker, to the software service selling business partner associated with the subscription, the software service query data in the second format; receiving by the software service broker, from the software service selling business partner associated with the subscription, software service response data, wherein the software service response data is responsive to the software service query data; sending by the software service broker, to the first software service buying business partner, the software service response data; and tracking, by the software service broker, usage by the first software service buying business partner of the at least one software service to which the first software service buying business partner subscribes.

In another example (related to limiting search results to business partners in various subsets of groups), the systems, methods and/or algorithms may further comprise: maintaining, by the software service broker, data identifying a second subset of the group of software service selling business partners and software service buying business partners, wherein the second subset comprises at least one of the software service selling business partners having a prior relationship with at least one of the software service buying business partners and wherein the second subset is distinct from the first subset; receiving by the software service broker, from a first one of the software service buying business partners in the second subset, a search request to identify at least one of the software services in the sets of defined software services; providing, by the software service broker, to the first software service buying business partner in the second subset, a search result identifying at least one of the software services in the sets of defined software services, wherein the search result is limited to the software service selling business partners in the second subset; receiving by the software service broker, from the first software service buying business partner in the second subset, data associated with a questionnaire, wherein the data associated with the questionnaire specifies at least one of the software services in the search result to which the first software service buying business partner in the second subset requests a subscription, and wherein the questionnaire includes an agreement by the first software service buying business partner in the second subset to the terms for the requested subscription including at least one of the associated pricing and the associated service level agreement; receiving by the software service broker, from the first software service buying business partner in the second subset, software service query data for querying the at least one software service to which the first software service buying business partner in the second subset subscribes, wherein the software service query data is in a first format; converting, by the software service broker, the software service query data in the first format into software service query data in a second format, wherein the second format is different from the first format; sending by the software service broker, to the software service selling business partner associated with the subscription of the first software service buying business partner in the second subset, the software service query data in the second format; receiving by the software service broker, from the software service selling business partner associated with the subscription of the first software service buying business partner in the second subset, software service response data, wherein the software service response data is responsive to the software service query data; sending by the software service broker, to the first one of the software service buying business partners in the second subset, the software service response data; and tracking, by the software service broker, usage by the first software service buying business partner in the second subset of the at least one software service to which the first one of the software service buying business partner in the second subset subscribes.

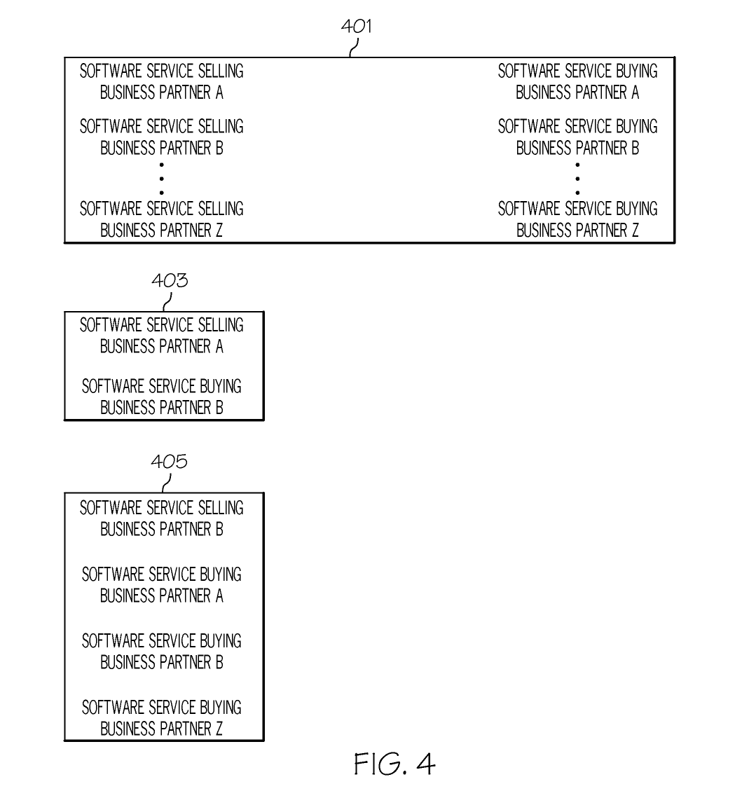

Referring now to FIG. 4, an example set of business partners and two example business partner subsets according to one embodiment of the present invention are shown. As seen, in this example, set 401 includes Software Service Selling Business Partner A, Software Service Selling Business Partner B, through Software Service Selling Business Partner Z (of course, any desired number of Software Service Selling Business Partner(s) may be included in the set). Further, in this example, set 401 includes Software Service Buying Business Partner A, Software Service Buying Business Partner B, through Software Service Buying Business Partner Z (of course, any desired number of Software Service Buying Business Partner(s) may be included in the set).

Still referring to FIG. 4, it is seen that in this example, subset 403 (which is a subset of set 401 wherein the members of the subset 403 have a prior relationship with one another) includes Software Service Selling Business Partner A and Software Service Buying Business Partner B (of course, any appropriate number of Software Selling Business Partner(s) and/or Software Buying Business Partner(s) may be included in this subset 403).

Further, it is seen that in this example that subset 405 (which is a subset of set 401 wherein the members of the subset 405 have a prior relationship with one another) includes Software Service Selling Business Partner B, Software Service Buying Business Partner A, Software Service Buying Business Partner B and Software Service Buying Business Partner Z (of course, any appropriate number of Software Selling Business Partner(s) and/or Software Buying Business Partner(s) may be included in this subset 405).

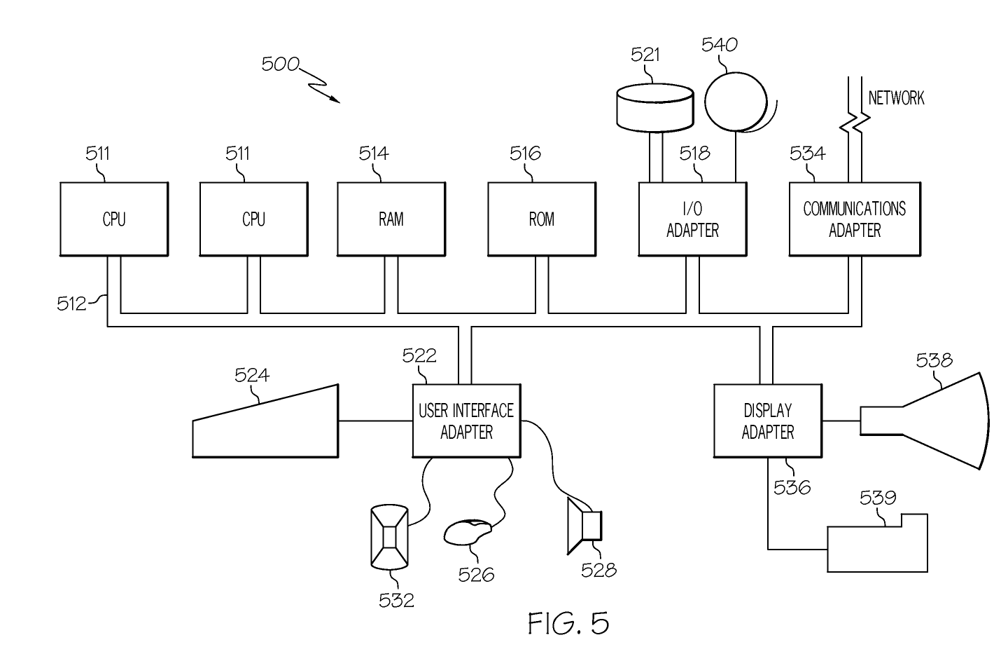

Referring now to FIG. 5, this figure shows a hardware configuration of computing system 500 according to an embodiment of the present invention. As seen, this hardware configuration has at least one processor or central processing unit (CPU) 511. The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 526, speaker 528, microphone 532, and/or other user interface device to the bus 512), a communications adapter 534 for connecting the system 500 to a data processing network, the Internet, an Intranet, a local area network (LAN), etc., and a display adapter 536 for connecting the bus 512 to a display device 538 and/or printer 539 (e.g., a digital printer or the like).

As described herein, in various examples a Services Registry, a Partner Services Registry, a Services Marketplace, a B2B Services Registry, a B2B Services Store and/or the like may be provided.

Further, as described herein, various embodiments provide integrated software services to and/or among business partners in a business-to-business “B2B” environment. Various specific examples provide one or more of the following: (1) automated provisioning of one or more software services (e.g., integrated software services) to a business partner, where the set of software services (and/or each individual software service) has an associated pricing, and/or services level agreement (“SLA”); (2) a services broker for pushing information between the business partners to allow automated provisioning of software services and billing, metering, throttling and/or controlling as well as security and SLA maintenance/management; (3) the ability to sell access to software services and negotiate the compensation for such software services; (4) the discovery of software services available by partner(s) using search-type capabilities (including, for example, based upon a party being within your network of partners); (5) tracking of software service(s) usage; (6) entering into agreements with certain partners; (7) brokering and selling software service(s) based on the discovery of partners; (8) partner exploration related to software services; and/or (9) contract and SLA negotiation (e.g., price, SLA terms).

In other examples, various embodiments may be applied in the context of any desired number of broker(s), seller(s) and/or buyer(s).

In other examples, various embodiments may be applied in the context of any desired number of broker website(s), seller website(s) and/or buyer websites(s).

In other examples, various embodiments provide for enforcing a contract (e.g., a service level agreement) via dynamic pricing and billing. In one specific example, under such dynamic pricing and billing, if the terms of a service level agreement are not met, a price charged to a buyer may be reduced. In another specific example, if a response time specified by a service level agreement is x seconds (e.g., 10 seconds) and the response time is not met (i.e., the response from the service provider took too long), the price charged to a buyer may be reduced.

In other examples, usage that is tracked and/or billed may be determined: by time (e.g., minutes of use, hours of use, days of use or months of use); by a data model (e.g., value of data used and/or accessed); and/or by a number of service accesses.

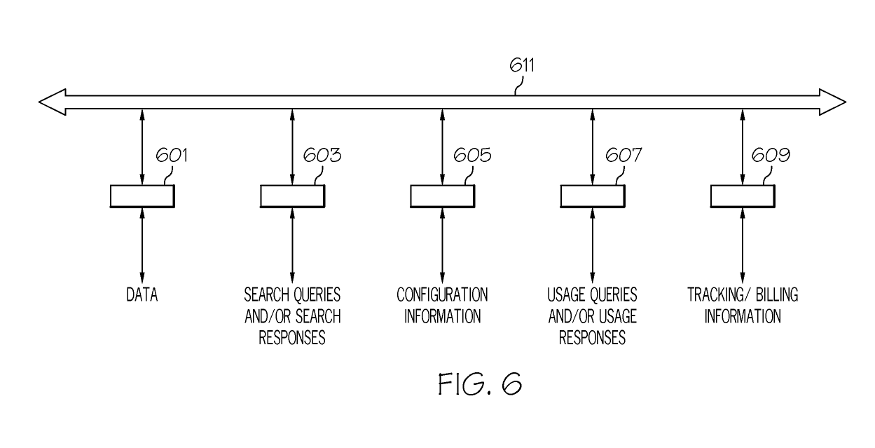

Referring now to FIG. 6, in another embodiment, a system providing the following elements may be provided: an input element 601, a search element 603, a configuration element 605, a software service utilization element 607, and a tracking element 609. Each of the input element 601, the search element 603, the configuration element 605, the software service utilization element 607, and the tracking element 609 may be operatively connected together via system bus 611. In one example, the input element 601 may receive various data, the search element 603 may perform various search functions, the configuration element 605 may aid in configuring one or more computers, the software utilization element 607 may provide for utilization of one or more software services and the tracking element 609 may provide for the tracking of usage of one or more software services. In another example, some or all of these elements may be implemented in a computer system of the type shown in FIG. 5.

In other examples, any steps described herein may be carried out in any appropriate desired order.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any programming language or any combination of one or more programming languages, including an object oriented programming language such as Java, Smalltalk, C++ or the like or a procedural programming language, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described herein with reference to flowchart illustrations and/or block diagrams of methods, systems and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus or other devices provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is noted that the foregoing has outlined some of the objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the features and applications of the invention. Other beneficial results can be realized by applying the disclosed invention in a different manner or modifying the invention in ways known to those familiar with the art. In addition, all of the examples disclosed herein are intended to be illustrative, and not restrictive.

What is claimed is:

1. A method implemented in a computer system for providing software service, the method comprising:
maintaining, by a software service broker, data identifying a plurality of software service selling business partners;
maintaining, by the software service broker, data identifying a plurality of software service buying business partners;
receiving by the software service broker, from each of the software service selling business partners, respective data defining a set of software services, wherein the respective data defining the set of software services includes for each of the software service selling business partners terms directed to at least one of an associated pricing and an associated service level agreement;
providing by the software service broker a search functionality that identifies at least one of the software services in the sets of defined software services;
receiving by the software service broker, from a first one of the software service buying business partners, a search request to identify at least one of the software services in the sets of defined software services;
providing, by the software service broker, to the first one of the software service buying business partners, a search result identifying at least one of the software services in the sets of defined software services;
receiving by the software service broker, from the first software service buying business partner, data associated with a questionnaire, wherein the data associated with the questionnaire specifies at least one of the software services in the search result to which the first software service buying business partner requests a subscription, and wherein the questionnaire includes an agreement by the first software service buying business partner to the terms for the requested subscription including at least one of the associated pricing and the associated service level agreement;
receiving by the software service broker, from the first software service buying business partner, software service query data for querying the at least one software service to which the first software service buying business partner subscribes, wherein the software service query data is in a first format;
converting, by the software service broker, the software service query data in the first format into software service query data in a second format, wherein the second format is different from the first format;
sending by the software service broker, to the software service selling business partner associated with the subscription, the software service query data in the second format;
receiving by the software service broker, from the software service selling business partner associated with the subscription, software service response data, wherein the software service response data is responsive to the software service query data;
sending by the software service broker, to the first software service buying business partner, the software service response data; and
tracking, by the software service broker, usage by the first software service buying business partner of the at least one software service to which the first software service buying business partner subscribes.

2. The method of claim 1, further comprising providing, by the software service broker, to the first software service buying business partner, provisioning data, wherein the provisioning data provides information directed to connecting via computer with the software service broker to obtain the at least one software service to which the first software service buying business partner subscribes.

3. The method of claim 1, wherein the tracking, by the software service broker, of the at least one software service to which the first software service buying business partner subscribes comprises billing the first software service buying business partner for use of the at least one software service to which the first software service buying business partner subscribes.

4. The method of claim 1, wherein the tracking, by the software service broker, of the at least one software service to which the first software service buying business partner subscribes comprises providing at least one payment to the software service selling business partner associated with the subscription for use of the at least one software service to which the first software service buying business partner subscribes.

5. The method of claim 1, further comprising converting, by the software service broker, the software service response data from a third format into software service response data in a fourth format, wherein the third format is different from the fourth format;
wherein the sending by the software service broker, to the first software service buying business partner, the software service response data comprises sending the software service response data in the fourth format.

6. The method of claim 1, wherein the steps are carried out in the order recited.

7. A computer readable storage medium, tangibly embodying a program of instructions executable by the computer for providing software service, the program of instructions, when executing, performing the following steps:
maintaining, by a software service broker, data identifying a plurality of software service selling business partners;
maintaining, by the software service broker, data identifying a plurality of software service buying business partners;
receiving by the software service broker, from each of the software service selling business partners, respective data defining a set of software services, wherein the respective data defining the set of software services includes for each of the software service selling business partners terms directed to at least one of an associated pricing and an associated service level agreement;
providing by the software service broker a search functionality that identifies at least one of the software services in the sets of defined software services;
receiving by the software service broker, from a first one of the software service buying business partners, a search request to identify at least one of the software services in the sets of defined software services;
providing, by the software service broker, to the first one of the software service buying business partners, a search result identifying at least one of the software services in the sets of defined software services;
receiving by the software service broker, from the first software service buying business partner, data associated with a questionnaire, wherein the data associated with the questionnaire specifies at least one of the software services in the search result to which the first software service buying business partner requests a subscription, and wherein the questionnaire includes an agreement by the first software service buying business partner to the terms for the requested subscription including at least one of the associated pricing and the associated service level agreement;
receiving by the software service broker, from the first software service buying business partner, software service query data for querying the at least one software service to which the first software service buying business partner subscribes, wherein the software service query data is in a first format;
converting, by the software service broker, the software service query data in the first format into software service query data in a second format, wherein the second format is different from the first format;
sending by the software service broker, to the software service selling business partner associated with the subscription, the software service query data in the second format;
receiving by the software service broker, from the software service selling business partner associated with the subscription, software service response data, wherein the software service response data is responsive to the software service query data;
sending by the software service broker, to the first software service buying business partner, the software service response data; and
tracking, by the software service broker, usage by the first software service buying business partner of the at least one software service to which the first software service buying business partner subscribes.

8. The computer readable storage medium of claim 7, further comprising providing, by the software service broker, to the first software service buying business partner, provisioning data, wherein the provisioning data provides information directed to connecting via computer with the software service broker to obtain the at least one software service to which the first software service buying business partner subscribes.

9. The computer readable storage medium of claim 7, wherein the tracking, by the software service broker, of the at least one software service to which the first software service buying business partner subscribes comprises billing the first software service buying business partner for use of the at least one software service to which the first software service buying business partner subscribes.

10. The computer readable storage medium of claim 7, wherein the tracking, by the software service broker, of the at least one software service to which the first software service buying business partner subscribes comprises providing at least one payment to the software service selling business partner associated with the subscription for use of the at least one software service to which the first software service buying business partner subscribes.

11. The computer readable storage medium of claim 7, further comprising converting, by the software service broker, the software service response data from a third format into software service response data in a fourth format, wherein the third format is different from the fourth format;
wherein the sending by the software service broker, to the first software service buying business partner, the software service response data comprises sending the software service response data in the fourth format.

12. The computer readable storage medium of claim 7, wherein the steps are carried out in the order recited.

13. A computer-implemented system for providing software service, the system comprising:
an input element, wherein the input element:
(a) receives data identifying a plurality of software service selling business partners;
(b) receives data identifying a plurality of software service buying business partners; and
(c) receives, from each of the software service selling business partners, respective data defining a set of software services, wherein the respective data defining the set of software services includes for each of the software service selling business partners terms directed to at least one of an associated pricing and an associated service level agreement;
a search element, wherein the search element:
(a) receives, from a first one of the software service buying business partners, a search request to identify at least one of the software services in the sets of defined software services;
(b) provides a search functionality such that at least one of the software services in the sets of defined software services can be identified; and
(c) provides, to the first one of the software service buying business partners, a search result identifying at least one of the software services in the sets of defined software services;
a configuration element, wherein the configuration element:
(a) receives, from the first software service buying business partner, data associated with a questionnaire, wherein the data associated with the questionnaire specifies at least one of the software services in the search result to which the first software service buying business partner requests a subscription, and wherein the questionnaire includes an agreement by the first software service buying business partner to the terms for the requested subscription including at least one of the associated pricing and the associated service level agreement;
a software service utilization element, wherein the software service utilization element:
(a) receives, from the first software service buying business partner, software service query data for querying the at least one software service to which the first software service buying business partner subscribes, wherein the software service query data is in a first format;
(b) converts the software service query data in the first format into software service query data in a second format, wherein the second format is different from the first format;
(c) sends, to the software service selling business partner associated with the subscription, the software service query data in the second format;
(d) receives, from the software service selling business partner associated with the subscription, software service response data, wherein the software service response data is responsive to the software service query data; and
(e) sends, to the first software service buying business partner, the software service response data; and
a tracking element, wherein the tracking element:
(a) tracks usage by the first software service buying business partner of the at least one software service to which the first software service buying business partner subscribes.

14. The system of claim 13, further comprising providing via the configuration element, to the first software service buying business partner, provisioning data, wherein the provisioning data provides information directed to connecting via computer with the software service utilization element to obtain the at least one software service to which the first software service buying business partner subscribes.

15. The system of claim 13, wherein the tracking of the at least one software service to which the first software service buying business partner subscribes comprises billing the first software service buying business partner for use of the at least one software service to which the first software service buying business partner subscribes.

16. The system of claim 13, wherein the tracking, of the at least one software service to which the first software service buying business partner subscribes comprises providing at least one payment to the software service selling business partner associated with the subscription for use of the at least one software service to which the first software service buying business partner subscribes.

17. The system of claim 13, wherein:
the software service utilization element converts the software service response data from a third format into software service response data in a fourth format, wherein the third format is different from the fourth format; and
the software service response data is sent to the first software service buying business partner in the fourth format.

18. The system of claim 13, further comprising a database, wherein the data received by the input element is stored in the database.

19. The system of claim 13, wherein each of the input element, the search element, the configuration element, the software service utilization element and the tacking element comprises a program of instructions executable by the computer.

20. The system of claim 13, wherein each of the input element, the search element, the configuration element, the software service utilization element and the tacking element carries out each associated step in the order recited.
